(19) United States
(12) Patent Application Publication
(10) Pub. No.: US 2025/0135982 A1
(43) Pub. Date: May 1, 2025

(54) SELF-UNLOADING MODULAR CONVEYOR DEVICE FOR STANDARD TRAILERS, TRUCKS, AND SIMILAR TRANSPORT VEHICLES, A METHOD OF CONVERTING A STANDARD TRAILER, TRUCK, OR SIMILAR TRANSPORT VEHICLE INTO A SELF-UNLOADING ONE; AND A METHOD OF MOVING AND SELF-UNLOADING LOOSE MATERIAL USING SAID SELF-UNLOADING MODULAR CONVEYOR DEVICE

(71) Applicants: ADALBERTO L SOTERO, MIAMI, FL (US); ROSA L CRUZ, HIALEAH, FL (US)

(72) Inventors: ADALBERTO L SOTERO, MIAMI, FL (US); ROSA L CRUZ, HIALEAH, FL (US)

(21) Appl. No.: 18/809,943

(22) Filed: Aug. 20, 2024

Related U.S. Application Data
(60) Provisional application No. 63/546,472, filed on Oct. 30, 2023.

(51) Int. Cl. B60P 1/38; B60P 3/22; B60P 3/42

(52) U.S. Cl. CPC B60P 1/38; B60P 3/2215; B60P 3/2245; B60P 3/42; B60Y 2304/076; B60Y 2400/405; B60Y 2400/406

(57) ABSTRACT

A self-unloading modular conveyor device designed for standard trailers, trucks, and similar transport vehicles, enabling them to transport and unload loose materials efficiently. The device generally includes a chassis, conveyor, motor, left door, right door, and front door, with optional components like a hydraulic power unit and a self-driven sandbagging device. Engineered for easy installation on the bed of a standard transport vehicle without permanent modifications, the device can be removed when not in use. The invention also provides methods for converting standard trailers, trucks, or similar transport vehicles into self-unloading ones; self-unloading loose material from the beds of standard transport vehicles; and moving and unloading loose material using the self-unloading modular conveyor device. This invention enables trailers, trucks, and similar transport vehicles to be suitable for efficiently transporting and self-unloading loose materials utilizing a conveyor mechanism.

### FIELD OF THE INVENTION

The present invention relates generally to a conveyor system. More specifically, the invention relates to a vehicle-mounted modular conveyor device that enables standard trailers, trucks, or similar transport vehicles to be suited for transporting and self-unloading loose or bulk flow materials using a conveyor mechanism.

The invention also includes a method of converting a standard trailer, truck, or similar transport vehicle into a self-unloading one, a method of self-unloading loose material (e.g. sand) from the bed of a standard trailer, truck, or similar transport vehicle, and a method of transporting and self-unloading loose material using the modular conveyor device.

### BACKGROUND OF THE INVENTION

Transport vehicles, such as trucks and trailers, play a critical role in cargo logistics, with each type tailored to specific needs. Box trucks, dry vans, and semi-trailers are ideal for transporting compact goods like furniture and appliances due to their spacious flatbeds. Conversely, dump trucks, end dump trailers, and live-bottom trailers are preferred for loose materials such as asphalt, grain, or sand, as their designs enable efficient unloading through mechanisms like tilting beds or conveyor systems.

Among these, live-bottom trailers are particularly notable for their ability to unload loose materials without the need to lift the bed, thanks to their integrated conveyor systems. However, despite their advantages, live-bottom trailers are often large, costly, and primarily suited for handling loose materials. Their design limitations restrict their versatility, making them less suitable for transporting compact cargo.

Currently, there are transport vehicles equipped with conveyor systems specifically designed for loose material transportation. However, these systems have not fully addressed the need for a versatile, cost-effective solution capable of efficiently handling loose materials while also being compatible with the transport of compact cargo. Consequently, there is a market demand for an innovative solution that enhances the versatility of transport vehicles with beds, enabling them to transport and unload loose materials as effectively as live-bottom trailers, while still retaining the capability to transport compact cargo economically and efficiently.

Several prior art devices and systems are relevant to solving this problem, but do not. For example, US Patent Application Publication No. 2022/0332238 discloses a live-bottom trailer featuring an integrated conveyor system with a frame that supports a conveyor, but the trailer is not suited for transporting compact cargo. U.S. Pat. No. 6,220,810 describes a device for moving bulk material with motor-driven chains supporting a conveyor belt, but the device does not include components for installing it into a standard trailer, truck, or similar transport vehicle.

However, these systems do not address the need for an easily installable, user-friendly conveyor system that can convert a standard trailer, truck, or similar transport vehicle into one suited for self-unloading loose materials like sand and dirt.

The present invention aims to fill this gap by providing a novel modular conveyor device that is easily installable on the bed of a standard trailer, truck, or similar transport vehicle. By equipping these vehicles with the device, they can efficiently transport and self-unload loose materials while retaining their original capability to carry compact cargo when the device is removed. This solution addresses the limitations posed by existing transport vehicle conveyor systems.

### SUMMARY OF THE INVENTION

The present invention introduces a modular conveyor device for unloading loose or bulk materials from transport vehicles, such as trailers and trucks, which are typically used for compact cargo. This device, when attached, allows these vehicles to efficiently transport and unload loose materials. Its detachable nature ensures that the vehicle's original function of transporting compact cargo is retained.

The modular conveyor device generally includes a chassis, motor, left door, right door, and front door. It may also feature a hydraulic power unit to drive the motor and a self-driven sandbagging device to unload loose material directly into sandbags. The invention enables vehicles traditionally designed for compact cargo to also handle and discharge loose materials effectively.

The invention also provides a method for converting a standard trailer, truck, or similar transport vehicle into a self-unloading one. This involves installing the modular conveyor device, which may include additional components like a hydraulic power unit and a self-driven sandbagging device for direct unloading into sandbags.

Another aspect of the invention is a method for self-unloading loose material from a vehicle bed. This method generally includes installing the modular conveyor device, loading the vehicle with loose material, opening the rear wall, powering the motor using the vehicle's engine or a hydraulic power unit, and using the conveyor to unload the material at the desired location.

The invention further encompasses a method of moving and unloading loose material, comprising: installing the modular conveyor device on a trailer, truck, or similar transport vehicle; loading said trailer, truck, or similar transport vehicle with loose material in a first location; transporting said loose material to a second location using said trailer, truck, or similar transport vehicle; unloading said loose material from said trailer, truck, or similar transport vehicle at a second location using said modular conveyor device.

Unlike existing vehicles that are purpose-built for either compact cargo or loose material, this invention offers a versatile solution. It provides an easily installable system for self-unloading loose materials from the beds of transport vehicles while preserving their ability to carry compact cargo. Additionally, it can be used in conjunction with other modular devices, such as the self-driven modular conveyor sandbagging device, to further enhance the unloading process.

### Main Advantages of the Present Invention

The device is easy to install and remove, minimizing downtime between cargo transport tasks.

Its detachable nature preserves the vehicle's original transport capabilities, allowing it to transition seamlessly between transporting loose materials and compact cargo. This versatility provides a significant advantage over systems that permanently alter a vehicle's configuration.

A key advantage of the modular conveyor device is its ability to dispense materials from a vehicle bed without raising the bed, enhancing operational safety by eliminating the risks associated with elevated truck beds during unloading. This feature allows operators to unload materials with greater confidence, improving both safety and efficiency.

In contrast to configuration centric systems where the entire truck bed is built around the conveyor or requires the installation of a separate bed, this modular device enhances cargo volume and payload capacity. It ensures that the truck bed remains versatile for both material transport and other cargo, eliminating the volume and weight limitations posed by configuration centric alternatives. Truck operators benefit from an unobstructed truck bed that retains its full cargo carrying capacity, even when the modular conveyor device is installed. This unobstructed design optimizes overall cargo volume and utility.

Additionally, the modular conveyor device offers an affordable solution compared to owning two separate vehicles-one dedicated to compact cargo transport and another solely for transporting loose material. By using this device, a single vehicle can efficiently handle both types of cargo, reducing the need for multiple specialized vehicles and lowering overall operational costs.

An innovative feature of the modular conveyor device is the utilization of curved shaped doors. This design choice is instrumental in maintaining the vehicle's center of gravity during material unloading, even while fully loaded. By strategically shaping the doors in a curved configuration, this invention effectively redistributes weight within the truck bed, optimizing load stability and safety. The curved doors evenly distribute weight across the truck, allowing for the transport of heavier loads without compromising safety. This design minimizes the risk of instability or tipping during unloading, particularly when the truck is fully laden.

The combination of transport versatility, safety features, and load management makes the modular conveyor device a pioneering solution in material transport and unloading. It aligns with the goals of enhancing efficiency and safety while preserving the multifunctional nature of the truck bed.

Additional features, as detailed in the specification and accompanying drawings.

### DETAILED DESCRIPTION OF DRAWINGS

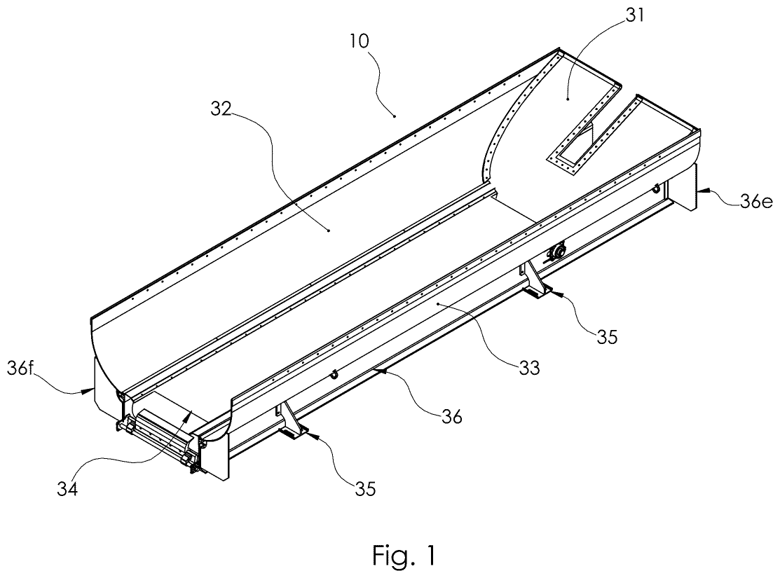

FIG. 1 is a perspective view showing the modular conveyor device having the left door, right door, and front door attached to the chassis.

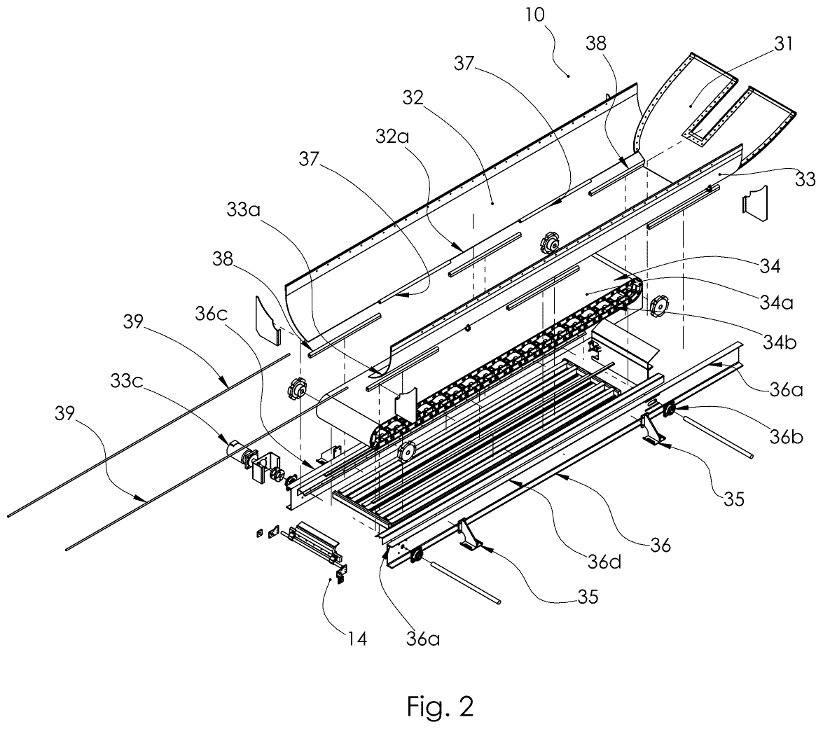

FIG. 2 is an exploded perspective view of the modular conveyor device of FIG. 1.

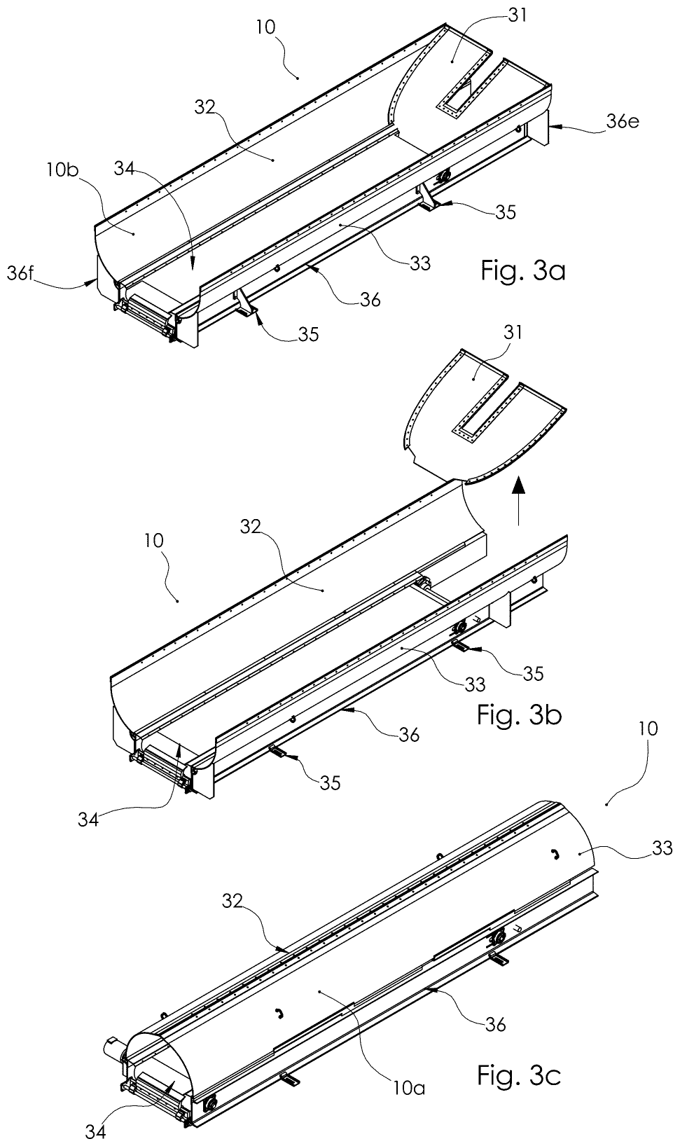

FIG. 3A is a perspective view of the modular conveyor device of FIG. 1 with the left door and right door in an open position.

FIG. 3B is a perspective view of the modular conveyor device of FIG. 3A with the front wall detached from the chassis.

FIG. 3C is a perspective view of the modular conveyor device having the left door and right door attached and having said left door and right door in a closed position.

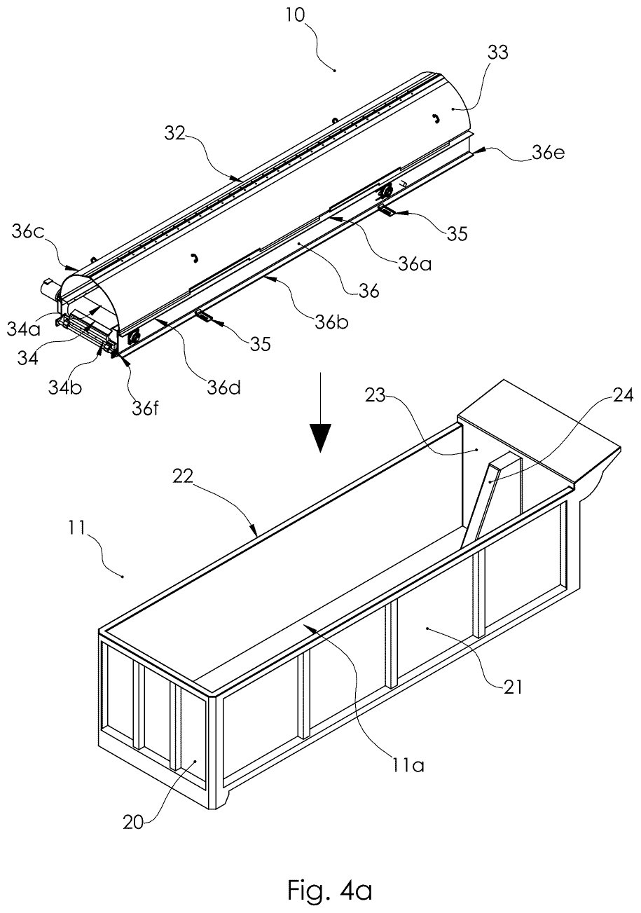

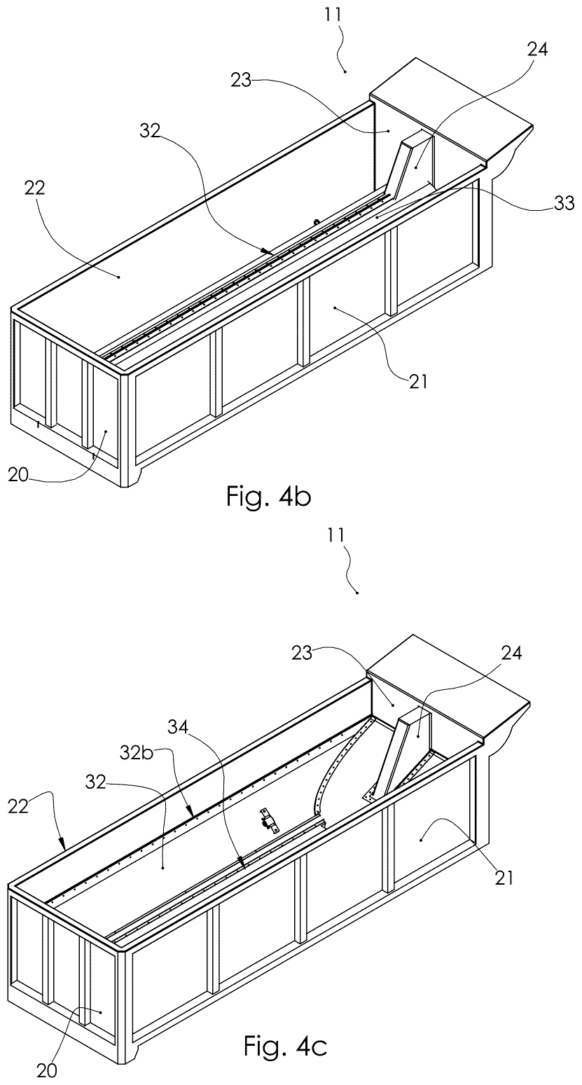

FIG. 4A is a perspective view of the modular conveyor device of FIG. 3C detached from the trailer.

FIG. 4B is a perspective view of the modular conveyor device of FIG. 4A attached to the bed of the trailer.

FIG. 4C is a perspective view of the modular conveyor device of FIG. 4B having the left door and right door in an open position and secured to the left wall and right wall of the trailer, and having the front door installed.

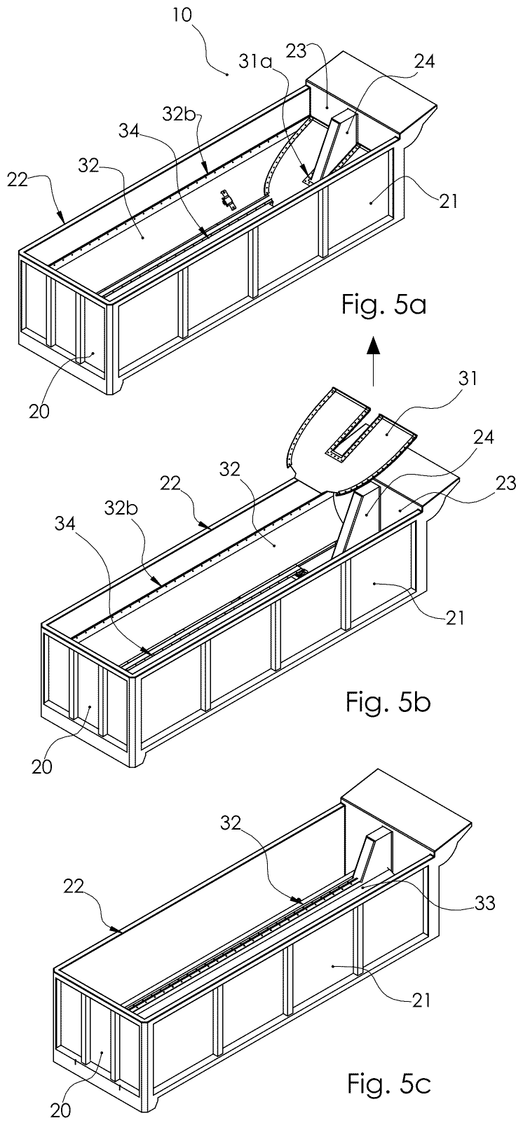

FIGS. 5A-C are similar to FIGS. 4A-C but in this case the front door is shown detached and then installed on the trailer.

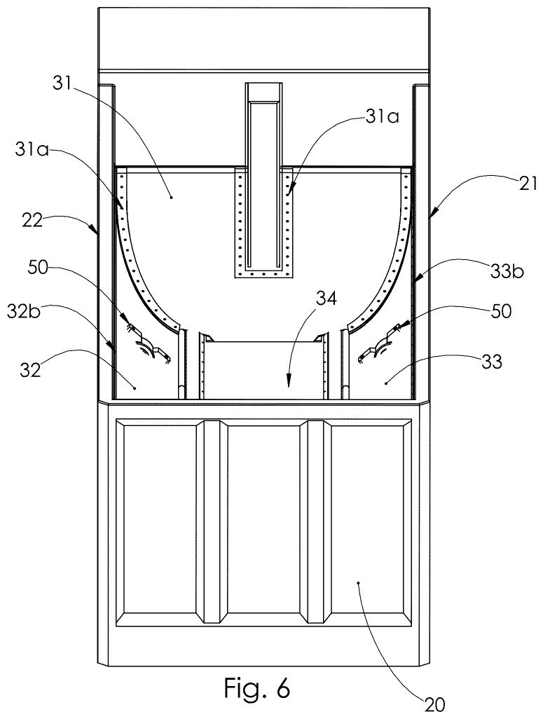

FIG. 6 is a rear perspective view of the modular conveyor device having curved left and right doors installed in a trailer.

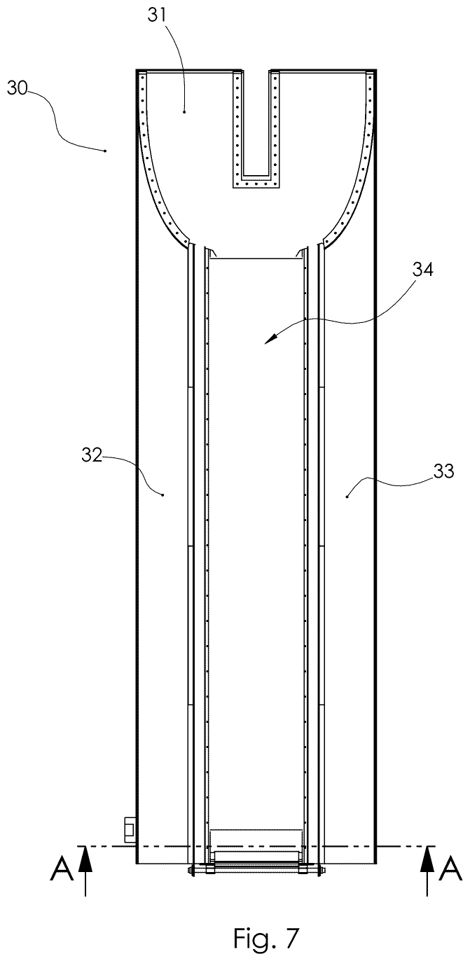

FIG. 7 is a top plan view of the modular conveyor device of FIG. 1.

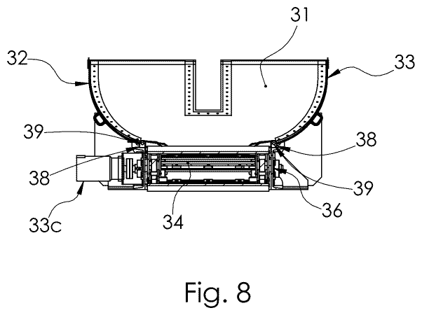

FIG. 8 is a cross-sectional view in accordance with A-A of FIG. 7.

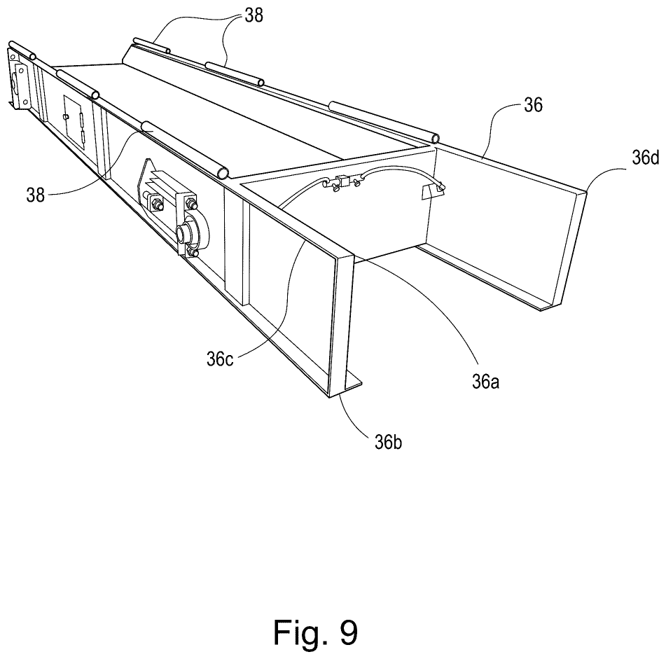

FIG. 9 is a perspective view of the chassis of the modular conveyor device.

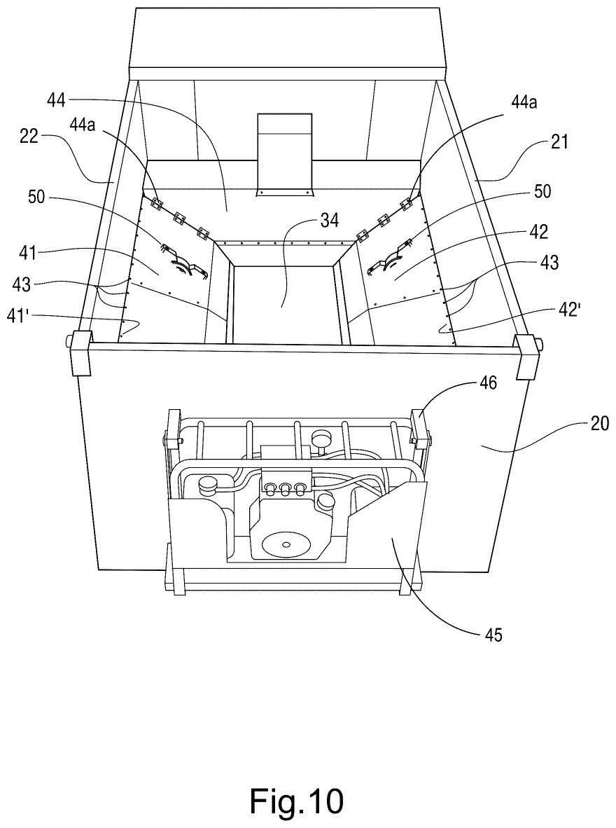

FIG. 10 is a rear perspective view of the modular conveyor device having rigid, inclined doors installed in a trailer, and a hydraulic power unit attached to rear wall of said trailer.

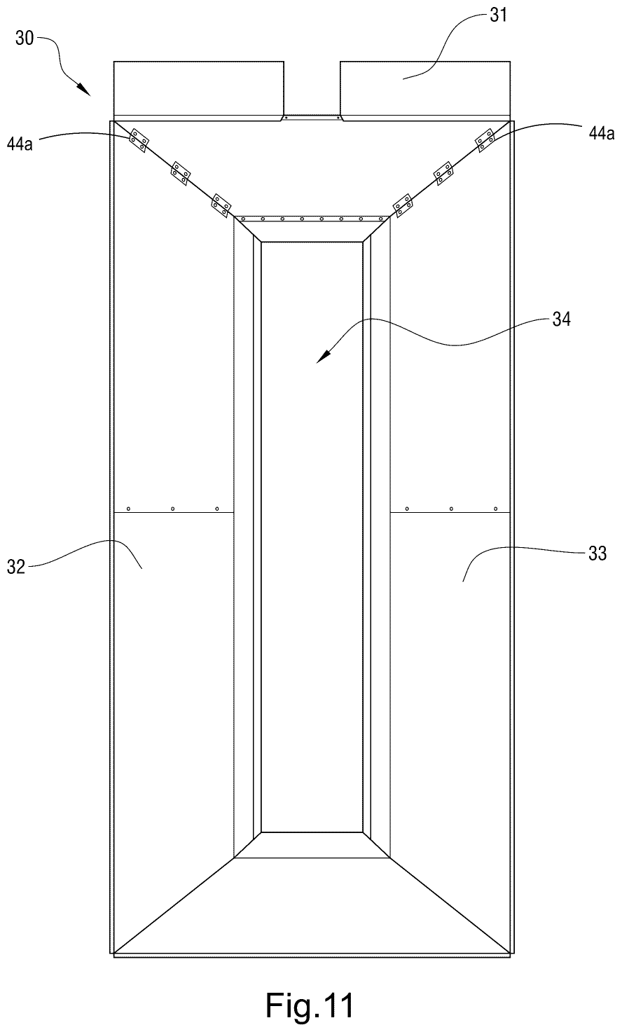

FIG. 11 is a top plan view of the modular conveyor device of FIG. 10.

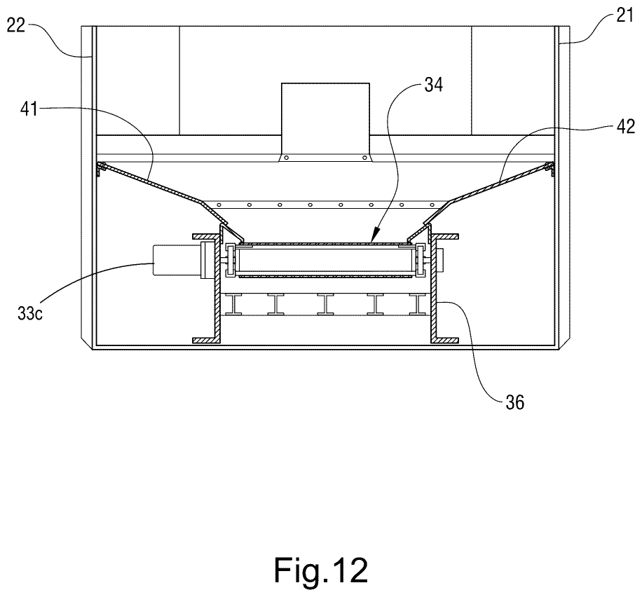

FIG. 12 is a cross-sectional view of FIG. 11. in accordance with A-A of FIG. 7.

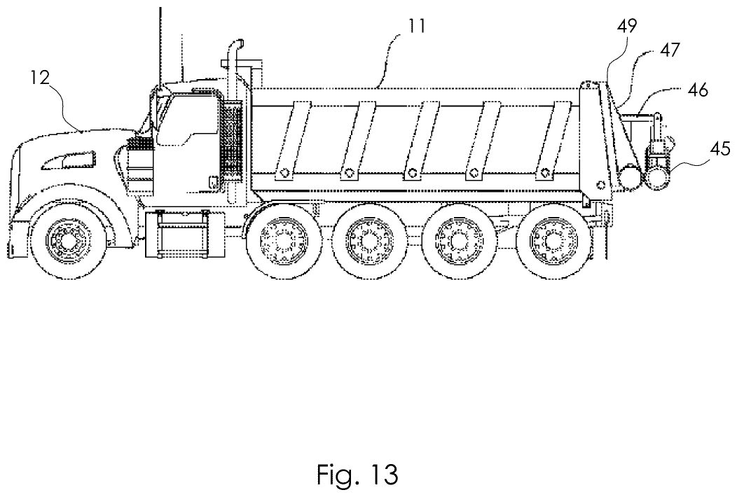

FIG. 13 is a left side view of a truck having a trailer attached, said trailer having a modular conveyor device installed, said modular conveyor device further comprising a self-driven modular sandbagging device and a hydraulic power unit connected to the exterior surface of said self-driven modular sandbagging device.

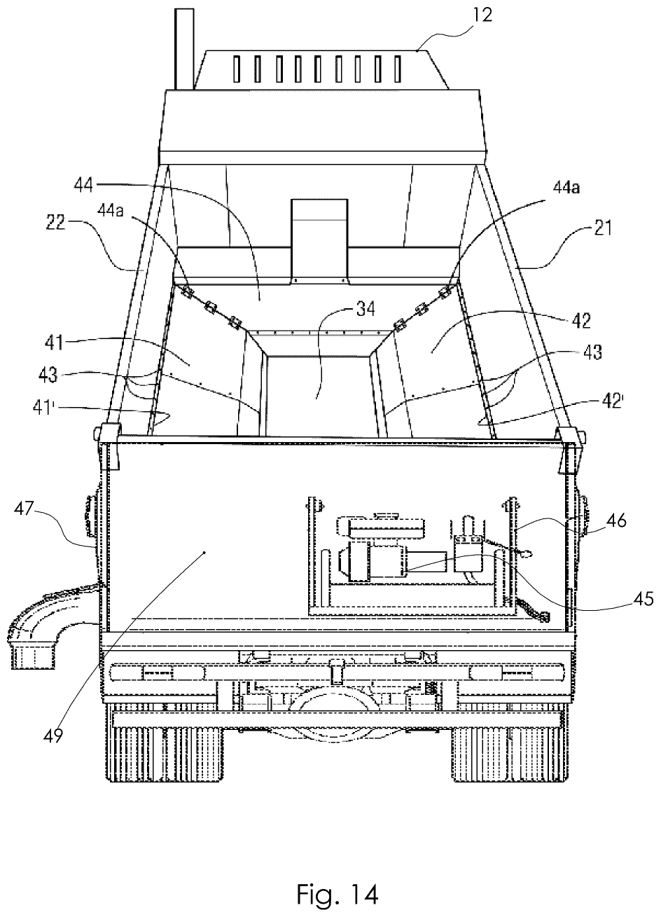

FIG. 14 is a rear perspective view of the truck of FIG. 13 with the modular conveyor device having rigid, inclined doors.

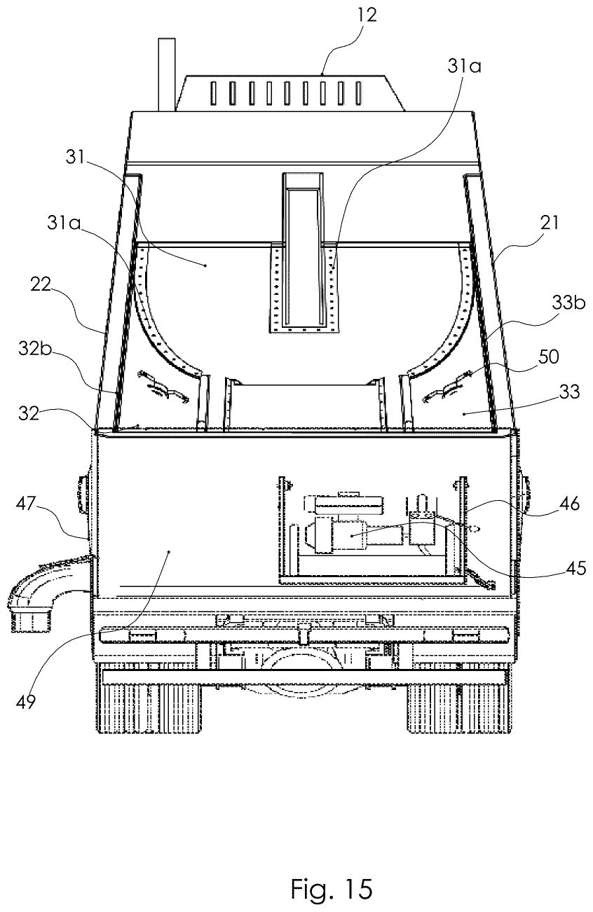

FIG. 15 is a rear perspective view of the truck of FIG. 13 with the modular conveyor device having curved left and right doors.

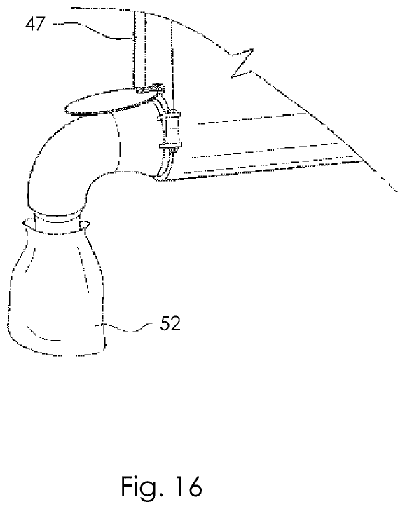

FIG. 16 is a perspective view of the self-driven modular sandbagging device of FIG. 13 discharging sand into a sandbag.

### DETAILED DESCRIPTION OF THE INVENTION

A trailer 11, truck, or a similar transport vehicle, as shown by FIG. 4A, typically includes a left wall 22, a right wall 21, a front wall 23 having a U-shaped projection 24, and a rear wall 20.

The main purpose of this invention is to create a system for converting a regular trailer 11, truck, or a similar transport vehicle commonly used for cargo transport into a vehicle that can efficiently transport and unload a variety of loose materials, including asphalt, grain, gravel, dirt, sand, and other similar substances, through the use of a conveyor mechanism.

The modular conveyor device 10 is designed to be securely mounted on the beds 11a of various trailers 11, trucks, and similar transport vehicles commonly used for cargo transport. Once installed, the device 10 enables the efficient transport and unloading of loose materials using its conveyor system. This system is capable of handling a variety of materials, including asphalt, grain, gravel, dirt, sand, and other similar substances. When the vehicle needs to return to its original functionality, the modular conveyor device 10 is uninstalled with a simple operation that usually takes some hours. If the original rear wall 20 is replaced by the self-driven sandbagging device 47 to enhance the performance of the modular conveyor device 10, then the original rear wall 20 is re-installed with a simple operation that usually takes some hours. The rest of the features of the vehicle are not affected or modified in any way.

The present inventive modular conveyor device 10, as shown by FIGS. 1-2, includes a chassis or conveyor frame 36, a conveyor 34, a motor 33c, a left door 32, a right door 33, and a front door 31. Specific details of the conveyor mechanism are omitted here, as it is a conventional component well-established in the field. The chassis 36 has a top surface 36a, a bottom surface 36b, a left side 36c, a right side 36d, and a front end 36e, a rear end 36f. Additionally, the chassis 36 has a securing means 35 connected to both the left side 36c and right side 36d of said chassis 36. The securing means 35 is defined by a set of slotted metal pieces 35 welded to the chassis 36, allowing the chassis 36 to be attached to the bed 11a of a transport vehicle 11 using bolts or screws. The conveyor 34 has a top surface 34a and bottom surface 34b, said bottom surface 34b of conveyor 34 is mounted to said top surface 36a of said chassis 36. The motor 33c is connected to the left side 36c of the chassis 36. The left door 32 of the modular conveyor device 10 has a longitudinal side 32a. The right door 33 of the modular conveyor device 10 has a longitudinal side 33a.

The modular conveyor device 10 has five preferred embodiments.

FIGS. 1-9 illustrate the first preferred embodiment of the device 10. In the first preferred embodiment, the chassis 36 has hinges 38 connected to both the left side 36c and right side 36d of the chassis 36. The left door 32 and right door 33 of the modular conveyor device 10 are curved in shape 32 and 33. The longitudinal side 32a of the left door 32 of the modular conveyor device 10 further comprises hinges 37. The longitudinal side 33a of the right door 33 of the modular conveyor device 10 further comprises hinges 37. The front door 31 has a rigid, inclined shape 31. An axis 39 is threaded twice through hinges 37 and 38: the first time to connect the left door 32 of the modular conveyor device 10 to the chassis 36, and the second time to connect the right door 33 of the modular conveyor device 10 to the chassis 36.

The modular conveyor device 10 of the first preferred embodiment is installed on a trailer 11, truck, or similar transport vehicle by sequentially mounting and securing its various components. First, the chassis 36 is mounted on the bed 11a of the vehicle 11 with both the left door 32 and right door 33 in a closed position 10a, as demonstrated by FIGS. 4A-4B. Once the chassis 36 is mounted, it is secured to the bed 11a of the vehicle 11 using securing means 35. Subsequently, the left door 32 and right door 33 of the modular conveyor device 10 are opened 10b until the left door 32 rests against the left wall 22 of the vehicle 11, and the right door 33 rests against the right wall 22 of the vehicle 11. Next, the left door 32 and right door 33 of the modular conveyor device 10 are secured to the left wall 22 and right wall 21 of the vehicle 11, respectively, using bolts or screws 32b and 33b, as demonstrated by FIG. 5B. The front door 31 of the modular conveyor device 10 is then mounted by fitting its central U-shaped opening into the projection 24 on the front wall 23 of the vehicle 11, as demonstrated by FIGS. 5A-5B. After the front door 31 is properly positioned, it is secured to the left door 32 of the modular conveyor device 10, the right door 33 of the modular conveyor device 10, and the front wall 23 of the vehicle 11 using bolts and screws 31a, as demonstrated by FIG. 6.

FIGS. 10-12 illustrate a second preferred embodiment of the modular conveyor device 10. This embodiment is also designed for integration into trailers 11, trucks, and similar transport vehicles commonly used for cargo transport, facilitating the efficient movement and unloading of loose materials using a conveyor system. However, in this embodiment, both the left door 41 and right door 42 of the modular conveyor device 10 are not curved or hinged to the chassis 36. Instead, the left door 32, right door 33, and front door 31 of the modular conveyor device 10 have a rigid, inclined shape 41, 42, and 44. The left door 41 is connected to the left wall 22 of a trailer 11, truck, or similar transport vehicle using bolts and screws 43, said left door 41 is connected to said front door 44 using edge links 44a, as demonstrated by FIG. 10. The right door 42 has a rigid, inclined shape, said right door 42 is connected to the right wall 21 of said trailer 11, truck, or similar transport vehicle using bolts and screws 43, said right door 42 is connected to said front door 44 using edge links 44a, as demonstrated by FIG. 10.

FIG. 10 illustrates a third preferred embodiment of the modular conveyor device 10. In this embodiment, the modular conveyor device 10 further comprises a hydraulic power unit 45 to power the motor 33c of the modular conveyor device 10 independent of a vehicle's engine. This feature enables the operator to utilize the modular conveyor device 10 even when installed on a trailer 11 that is detached from a truck X, maintaining full functionality powered solely by the hydraulic power unit 45. As the hydraulic power unit 45 is a conventional component well-known in the industry, specific details are not provided here. The hydraulic power unit 45 is connected to the rear wall 20 of a trailer 11, truck, or similar transport vehicle by a pump support 46, as shown by FIG. 10.

FIG. 15 illustrates a fourth preferred embodiment of the modular conveyor device 10. In this embodiment, the modular conveyor device 10 further comprises a hydraulic power unit 45 and a self-driven modular sandbagging device 47. The hydraulic power unit 45 allows the modular conveyor device 10 to operate independently of a vehicle's engine, as previously described. Additionally, the self-driven modular sandbagging device 47 enhances the system's performance by enabling the operator to unload loose material directly into sandbags 52 using the conveyor of the modular conveyor device 10, rather than depositing the material at a drop site. Specific details of the sandbagging device 47 are not provided, as it is a standard, well-established component in the field. The self-driven modular sandbagging device 47 is installed by replacing the rear wall 20 of the trailer 11, truck, or similar transport vehicle, with the sandbagging device 52 that effectively serves as the replacement tailgate. The hydraulic power unit 45 is connected to the exterior surface 49 of the self-driven modular sandbagging device 47 by a pump support 46, as demonstrated by FIG. 15.

FIG. 15 illustrates a fifth preferred embodiment of the modular conveyor device 10. In this embodiment, the modular conveyor device 10 further comprises a belt scraper 14, a vibrator or vibration motor 50, and a remote controller. The belt scraper 14 is connected to the rear end 12 of the chassis 36 to clean the conveyor 34 by removing any residual material, ensuring efficient and continuous operation. The vibrator or vibration motor 50 is connected to the right door 32, left door 33, or front door 31 of the modular conveyor device 10, as well as the left wall 22, right wall 21, or front wall 23 of the vehicle 11, to prevent loose material from adhering to these surfaces. A remote controller allows operators to start, stop, or adjust the speed of the movement of the top surface 34a of the conveyor 34.

A remote controller allows operators to start, stop, and adjust the speed of the conveyor system remotely, providing better control over the material handling process.

The motor 33c of the modular conveyor device 10 may be a mechanical motor, an electric motor, a hydraulic motor, or any other suitable motor known in the art. The conveyor 34 of the modular conveyor device 10 may be a belt-drive, chain-drive, shaft-drive, an endless conveyor, or any other suitable conveyor known in the art.

The chassis 36, left door 32, right door 33, and front door 31 of the modular conveyor device 10 may be made of steel, aluminum, fiberglass reinforced plastic (FRP), wood, composite materials, or any other suitable material known in art. The conveyor 34 may be made of rubber, PVC, polyurethane, fabric, metal, silicone, or any other suitable material known in the art. The belt scraper 14 may be made of polyurethane, rubber, or metal, or any other suitable material known in the art.

The modular conveyor device 10 may be manufactured by any suitable process known in the art.

The invention also encompasses a method of converting a standard trailer 11, truck, or similar transport vehicle, into a self-unloading trailer, truck, or similar transport vehicle, comprising: attaching a curved left door 32 to the left side 36c of the chassis 36 of the modular conveyor device 10 using hinges 37 and 38 and an axis 39; attaching a curved right door 33 to the right side 36d of said chassis 36 of said modular conveyor device 10 using hinges 37 and 38 and an axis 39; positioning said left door 32 and said right door 33 of said modular conveyor device 10 in a closed position 10a; placing said chassis 36 of said modular conveyor device 10 on the bed 11a of a trailer 11, truck, or similar transport vehicle; securing said chassis 36 of said modular conveyor device 10 to said bed 11a of said trailer 11, truck, or similar transport vehicle using securing means 35 and bolts or screws; positioning said left door 32 and said right door 33 of said modular conveyor device 10 in an open position 10b; securing said left door 32 of said modular conveyor device 10 to the left wall 22 of said trailer 11, truck, or similar transport vehicle using bolts or screws 32b; securing said right door 33 of said modular conveyor device 10 to the right wall 21 of said trailer 11, truck, or similar transport vehicle using bolts and screws 33b; placing the front door 31 of said modular conveyor device 10 on the front wall 23 of said trailer 11, truck, or similar transport vehicle; and securing said front door 31 of said modular conveyor device 10 to said front wall 23 of said trailer 11, truck, or similar transport vehicle, said left door 32 of said modular conveyor device 10, and said right door 33 of said modular conveyor device 10 using bolts or screws 31a.

The invention also encompasses a method of converting a standard trailer 10, truck, or similar transport vehicle, into a self-unloading trailer, truck, or similar transport vehicle, comprising: placing the chassis 36 of the modular conveyor device 10 on the bed 11a of a trailer 11, truck, or similar transport vehicle; securing the chassis 36 of said modular conveyor device 10 to said bed 11a of said trailer 11, truck, or similar transport vehicle using securing means 35 and bolts or screws; attaching the rigid, inclined left door 41 to the left side 36c of said chassis 36 of said modular conveyor device 10 using bolts or screws 43; attaching the rigid, inclined right door 42 to the right side 36d of said chassis 36 of said modular conveyor device 10 using bolts or screws 43; securing said rigid, inclined left door 41 of said modular conveyor device 10 to the left wall 22 of said trailer 11, truck, or similar transport vehicle using bolts and screws 43; securing said rigid, inclined right door 42 of said modular conveyor device 10 to the right wall 21 of said trailer 11, truck, or similar transport vehicle using bolts and screws 43; placing the front door 44 of said modular conveyor device 10 on the front wall 23 of said trailer 11, truck, or similar transport vehicle; and securing said front door 44 of said modular conveyor device 10 to said front wall 23 of said trailer 11, truck, or similar transport vehicle, said left door 41 of said modular conveyor device 10, and said right door 42 of said modular conveyor device 10 using edge links 44a.

The invention also encompasses a method of self-unloading loose material from the bed 11a of a trailer 11, truck, or similar transport vehicle, comprising: installing the modular conveyor device 10 having a chassis 36, conveyor 34, motor 33c, left door 32, right door 33, and front door 31, on a trailer, truck, or similar transport vehicle; loading said bed 11a of said trailer 11, truck, or similar transport vehicle with loose material; opening the rear wall 20 of said trailer 11, truck, or similar transport vehicle; powering the motor 33c of said modular conveyor device 10 using the truck's engine; and unloading said loose material onto the drop site using said conveyor 34 of said modular conveyor device 10.

The invention also encompasses a method of self-unloading loose material from the bed 11a of a trailer 11, truck, or similar transport vehicle, comprising: installing the modular conveyor device 10 having a chassis 36, conveyor 34, motor 33c, left door 32, right door 33, and front door 31, and hydraulic power unit 45 on a trailer 11, truck, or similar transport vehicle; loading said bed 11a of said trailer 11, truck, or similar transport vehicle with loose material; opening the rear wall 20 of said trailer 11, truck, or similar transport vehicle; powering the motor 33c of said modular conveyor device 10 using said hydraulic power unit 45; and unloading said loose material onto the drop site using said conveyor 34 of said modular conveyor device 10. This method, further comprising: detaching the trailer 11 from the truck 12 or similar transport vehicle; and unloading said loose material onto the drop site when the trailer 11 is detached from said truck 12 or similar transport vehicle.

The invention also encompasses a method of self-unloading loose material from the bed 11a of a trailer 11, truck, or similar transport vehicle, comprising: installing the modular conveyor device 10 having a chassis 36, conveyor 34, motor 33c, left door 32, right door 33, front door 31, hydraulic power unit 45, and the self-driven sandbagging device 47, on a trailer 11, truck, or similar transport vehicle; loading said bed 11a of said trailer, truck, or similar transport vehicle with loose material; opening the rear wall 20 of said trailer, truck, or similar transport vehicle; powering the motor 33c of said modular conveyor device using said hydraulic power unit 45; and unloading said loose material directly into sandbags 52 using said conveyor 34 of said modular conveyor device 10 and said self-driven sandbagging device 47. This method, further comprising: detaching the trailer 11 from the truck 12 or similar transport vehicle; and unloading said loose material directly into sandbags 52 when the trailer 11 is detached from said truck 12 or similar transport vehicle.

The invention also encompasses a method of self-unloading loose material from the bed 11a of a trailer 11, truck, or similar transport vehicle as in claim 21, 22, 23, 24, or 25, further comprising: using a remote controller to control the conveyor 34 of the modular conveyor device 10.

From the above disclosure of the detailed description of the present invention and the preceding summary of the preferred embodiments, those skilled in the art will comprehend the various modifications to which the present invention is susceptible. Therefore, I desire to be limited only by the scope of the following claims equivalents thereof.

The invention claimed is:

1. A modular conveyor device, comprising:
a chassis having a top surface, a bottom surface, a front end, a rear end, a left side, and a right side;
a securing means connected to said left side of said chassis;
a securing means connected to said right side of said chassis;
a conveyor having a top surface and bottom surface, said bottom surface of said conveyor mounted to said top surface of said chassis;
a motor connected to said left side of said chassis;
a left door having a longitudinal side;
a right door having a longitudinal side; and
a front door.

2. A modular conveyor device as in claim 1, wherein:
said chassis further comprises hinges connected to said left side of said chassis and said right side of said chassis;
said left door has a curved shape and further comprises hinges on said longitudinal side of said left door, said left door is connected to said left side of said chassis by an axis threaded through said hinges of said longitudinal side of said left door and said hinges of said left side of said chassis;
said right door has a curved shape and further comprises hinges on said longitudinal side of said right door, said right door is connected to said right side of said chassis by an axis threaded through said hinges of said longitudinal side of said right door and said hinges of said right side of said chassis; and
said front door has a rigid, inclined shape.

3. A modular conveyor device as in claim 1, wherein:
said left door has a rigid, inclined shape, said left door is connected to the left wall of a trailer, truck, or similar transport vehicle using bolts and screws, said left door is connected to said front door using edge links;
said right door has a rigid, inclined shape, said right door is connected to the right wall of said trailer, truck, or similar transport vehicle using bolts and screws, said right door is connected to said front door using edge links; and
said front door has a rigid, inclined shape.

4. A modular conveyor device as in claim 2 or 3, further comprising:
a hydraulic power unit connected to the rear wall of a trailer, truck, or similar transport vehicle by a pump support.

5. A modular conveyor device as in claim 4, further comprising:
a belt scraper connected to said rear end of said chassis.

6. A modular conveyor device as in claim 5, further comprising:
a vibration motor connected to said right door, left door, or front door of said modular conveyor device, or connected to said left wall, right wall, or front wall of said trailer, truck or similar transport vehicle.

7. A modular conveyor device as in claim 6, further comprising:
a remote controller.

8. A modular conveyor device as in claim 2 or 3, further comprising:
a self-driven modular sandbagging device connected to said trailer 11, truck, or similar transport vehicle by replacing the rear wall of said trailer 11, truck, or similar transport vehicle; and
a hydraulic power unit connected to the exterior surface of the self-driven modular sandbagging device by a pump support.

9. A modular conveyor device as in claim 8, further comprising:
a belt scraper connected to said rear end of said chassis.

10. A modular conveyor device as in claim 9, further comprising:
a vibration motor connected to said right door, left door, or front door of said modular conveyor device, or connected to said left wall, right wall, or front wall of said trailer, truck or similar transport vehicle.

11. A modular conveyor device as in claim 10, further comprising a remote controller.

12. The modular conveyor device of claim 7 or 11, wherein the securing means is a set of slotted metal pieces welded to the chassis.

13. The modular conveyor device of claim 7 or 11, wherein the motor is a mechanical motor.

14. The modular conveyor device of claim 7 or 11, wherein the motor is an electric motor.

15. The modular conveyor device of claim 7 or 11, wherein the motor is a hydraulic motor.

16. The modular conveyor device of claim 7 or 11, wherein the conveyor is a belt-drive.

17. The modular conveyor device of claim 7 or 11, wherein the conveyor is a chain-drive.

18. The modular conveyor device of claim 7 or 11, wherein the conveyor is a shaft-drive.

19. A method of converting a standard trailer, truck, or similar transport vehicle, into a self-unloading trailer, truck, or similar transport vehicle, comprising:
attaching a curved left door to the left side of the chassis of the modular conveyor device using hinges and an axis;
attaching a curved right door to the right side of said chassis of said modular conveyor device using hinges and an axis;
positioning said left door and said right door of said modular conveyor device in a closed position;
placing said chassis of said modular conveyor device on the bed of a trailer, truck, or similar transport vehicle;
securing said chassis of said modular conveyor device to said bed of said trailer, truck, or similar transport vehicle using securing means and bolts or screws;
positioning said left door and said right door of said modular conveyor device in an open position;
securing said left door of said modular conveyor device to the left wall of said trailer, truck, or similar transport vehicle using bolts and screws;
securing said right door of said modular conveyor device to the right wall of said trailer, truck, or similar transport vehicle using bolts and screws;
placing the front door of said modular conveyor device on the front wall of said trailer, truck, or similar transport vehicle; and
securing said front door of said modular conveyor device to said front wall of said trailer, truck, or similar transport vehicle, said left door of said modular conveyor device, and said right door of said modular conveyor device using bolts and screws.

20. A method of converting a standard trailer, truck, or similar transport vehicle, into a self-unloading trailer, truck, or similar transport vehicle, comprising:
placing the chassis of the modular conveyor device on the bed of a trailer, truck, or similar transport vehicle;
securing the chassis of said modular conveyor device to said bed of said trailer, truck, or similar transport vehicle using securing means and bolts or screws;
attaching the rigid, inclined left door to the left side of said chassis of said modular conveyor device using bolts and screws;
attaching the rigid, inclined right door to the right side of said chassis of said modular conveyor device using bolts and screws;
securing said rigid, inclined left door of said modular conveyor device to the left wall of said trailer, truck, or similar transport vehicle using bolts and screws;
securing said rigid, inclined right door of said modular conveyor device to the right wall of said trailer, truck, or similar transport vehicle using bolts and screws;
placing the front door of said modular conveyor device on the front wall of said trailer, truck, or similar transport vehicle; and
securing said front door of said modular conveyor device to said front wall of said trailer, truck, or similar transport vehicle, said left door of said modular conveyor device, and said right door of said modular conveyor device using bolts and screws.

21. A method of self-unloading loose material from the bed of a trailer, truck, or similar transport vehicle, comprising:
installing the modular conveyor device having a chassis, conveyor, motor, left door, right door, and front door, on a trailer, truck, or similar transport vehicle;
loading said bed of said trailer, truck, or similar transport vehicle with loose material;
opening the rear wall of said trailer, truck, or similar transport vehicle;
powering the motor of said modular conveyor device using the truck's engine; and
unloading said loose material onto the drop site using said conveyor of said modular conveyor device.

22. A method of self-unloading loose material from the bed of a trailer, truck, or similar transport vehicle, comprising:
installing the modular conveyor device having a chassis, conveyor, motor, left door, right door, front door, and hydraulic power unit on a trailer, truck, or similar transport vehicle;
loading said bed of said trailer, truck, or similar transport vehicle with loose material;
opening the rear wall of said trailer, truck, or similar transport vehicle;
powering the motor of said modular conveyor device using said hydraulic power unit; and
unloading said loose material onto the drop site using said conveyor of said modular conveyor device.

23. A method of self-unloading loose material from the bed of a trailer, truck, or similar transport vehicle as in claim 22, further comprising:
detaching the trailer from the truck or similar transport vehicle; and
unloading said loose material onto the drop site when the trailer is detached from said truck or similar transport vehicle.

24. A method of self-unloading loose material from the bed of a trailer, truck, or similar transport vehicle, comprising:
installing the modular conveyor device having a chassis, conveyor, motor, left door, right door, front door, hydraulic power unit, and the self-driven sandbagging device, on a trailer, truck, or similar transport vehicle;
loading said bed of said trailer, truck, or similar transport vehicle with loose material;
opening the rear wall of said trailer, truck, or similar transport vehicle;
powering the motor of said modular conveyor device using said hydraulic power unit; and
unloading said loose material directly into sandbags using said conveyor of said modular conveyor device and said self-driven sandbagging device.

25. A method of self-unloading loose material from the bed of a trailer, truck, or similar transport vehicle as in claim 24, further comprising:
detaching the trailer from the truck or similar transport vehicle; and
unloading said loose material directly into sandbags when the trailer is detached from said truck or similar transport vehicle.

26. A method of self-unloading loose material from the bed of a trailer, truck, or similar transport vehicle as in claim 21, 22, 23, 24, or 25, further comprising:
using a remote controller to control the movement of the top surface of said conveyor of said modular conveyor device.

27. A method of moving and unloading loose material, comprising:
installing the modular conveyor device on a trailer, truck, or similar transport vehicle;
loading said trailer, truck, or similar transport vehicle with loose material in a first location;
transporting said loose material to a second location using said trailer, truck, or similar transport vehicle;
unloading said loose material from said trailer, truck, or similar transport vehicle at a second location using said modular conveyor device.
